(19) United States
(12) Patent Application Publication
(10) Pub. No.: US 2025/0077842 A1
(43) Pub. Date: Mar. 6, 2025

(54) SELECTIVELY CONDITIONING LAYERS OF A NEURAL NETWORK WITH STYLIZATION PROMPTS FOR DIGITAL IMAGE GENERATION

(71) Applicant: Adobe Inc., San Jose, CA (US)

(72) Inventors: Hareesh Ravi, San Jose, CA (US); Sachin Kelkar, Santa Clara, CA (US); Ajinkya Gorakhnath Kale, San Jose, CA (US)

(21) Appl. No.: 18/459,186

(22) Filed: Aug. 31, 2023

(51) Int. Cl. G06N 3/045; G06N 3/0475

(52) U.S. Cl. CPC G06N 3/045; G06N 3/0475

(57) ABSTRACT

The present disclosure relates to systems, non-transitory computer-readable media, and methods for selectively conditioning layers of a neural network and utilizing the neural network to generate a digital image. In particular, in some embodiments, the disclosed systems condition an upsampling layer of a neural network with an image vector representation of an image prompt. Additionally, in some embodiments, the disclosed systems condition an additional upsampling layer of the neural network with a text vector representation of a text prompt without the image vector representation of the image prompt. Moreover, in some embodiments, the disclosed systems generate, utilizing the neural network, a digital image from the image vector representation and the text vector representation.

### BACKGROUND

Recent developments in hardware and software platforms have led to innovations in systems and methods for digital image generation. For example, existing systems can utilize various generative machine learning models to create digital images according to different prompts or inputs. Thus, for example, some existing systems can utilize diffusion neural networks to generate a digital image from a text input. Despite these advances, however, many existing systems continue to demonstrate a number of deficiencies or drawbacks, particularly with regard to accuracy, efficiency, and flexibility of implementing computing devices.

### BRIEF SUMMARY

Embodiments of the present disclosure provide benefits and/or solve one or more problems in the art with systems, non-transitory computer-readable media, and methods for selectively conditioning layers of a neural network with prompt information to generate a digital image. In particular, in some embodiments, the disclosed systems disentangle style information from content information contained in a prompt by controlling which layers of the neural network receive style prompts and which layers receive content prompts. For example, in some implementations, the disclosed systems determine whether a prompt (e.g., a text prompt, an image prompt) primarily contains style information or content information, and selects which layers of the neural network to receive the prompt as input. In some embodiments, the disclosed systems condition high-resolution layers of the neural network with style information (e.g., representations of an image prompt). Furthermore, in some embodiments, the disclosed systems condition low-resolution layers of the neural network with content information (e.g., representations of a text prompt).

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a selective layer conditioning system operates in accordance with one or more embodiments.

FIG. 2 illustrates the selective layer conditioning system generating a digital image from an image prompt and a text prompt utilizing selective conditioning of a neural network in accordance with one or more embodiments.

FIG. 3 illustrates the selective layer conditioning system generating cross attention maps for a digital image and a text prompt in accordance with one or more embodiments.

FIG. 4 illustrates the selective layer conditioning system utilizing conditioning for a diffusion neural network to generate a digital image from a noise representation, an image prompt, and a text prompt in accordance with one or more embodiments.

FIG. 5 illustrates the selective layer conditioning system conditioning layers of a neural network in accordance with one or more embodiments.

FIG. 6 illustrates the selective layer conditioning system conditioning layers of a neural network in accordance with one or more embodiments.

FIG. 7 illustrates the selective layer conditioning system conditioning layers of a neural network in accordance with one or more embodiments.

FIG. 8 illustrates the selective layer conditioning system providing a user interface for controlling conditional settings for an image prompt and a text prompt via a style-and-content-weight controller in accordance with one or more embodiments.

FIG. 9 illustrates example outputs of the selective layer conditioning system according to various conditional settings in accordance with one or more embodiments.

FIG. 10 illustrates a diagram of an example architecture of the selective layer conditioning system in accordance with one or more embodiments.

FIG. 11 illustrates a flowchart of a series of acts for selectively conditioning layers of a neural network and generating a digital image in accordance with one or more embodiments.

FIG. 12 illustrates a block diagram of an example computing device for implementing one or more embodiments of the present disclosure.

### DETAILED DESCRIPTION

This disclosure describes one or more embodiments of a selective layer conditioning system that selectively conditions layers of a neural network for digital image generation. Existing digital image generation systems suffer from a number of technical deficiencies, including inaccuracy, inefficiency, and inflexibility of implementing computing devices. In particular, existing systems often inaccurately generate digital images according to an intent underlying a prompt. To illustrate, conventional systems can receive text prompts indicating the desired contents of a digital image, but often generate resulting digital images that fail to accurately reflect both the content and style reflected within the input text prompts.

Conventional systems also struggle with operational inflexibility. For example, existing systems often process prompt information through each layer of a neural network. As discussed above, this approach leads existing systems to generate a digital image that does not capture a design intent for the digital image. Moreover, some existing systems inflexibly limit the types and combinations of prompts. For example, many existing systems do not permit both image prompts and text prompts for image generation.

Conventional systems are also computationally inefficient. For example, conventional systems often require unique training procedures to fine tune learned parameters for particular tasks or functions. For instance, to generate certain styles, conventional systems often utilize additional (and computationally expensive) training procedures unique to the desired output. Thus, existing systems often require specialized training or modified architecture (e.g., additional encoders) to process style and content information in a prompt.

In some embodiments, the selective layer conditioning system selectively conditions different layers of a neural network with style and/or content information to generate a digital image. For example, in some embodiments, the selective layer conditioning system determines whether a prompt (e.g., a text prompt, an image prompt) primarily contains style information or content information, and selects layers of the neural network to receive the prompt as an input. For instance, in some implementations, the selective layer conditioning system processes style information through high-resolution layers of the neural network. Additionally, in some implementations, the selective layer conditioning system processes content information through low-resolution layers of the neural network.

Additionally, in some embodiments, the selective layer conditioning system provides a user interface by which to control which denoising iterations of a diffusion neural network and/or which layers of a neural network (e.g., within a denoising iteration) receive which conditional inputs. For example, the selective layer conditioning system provides a style-and-content-weight controller offering degrees (e.g., a sliding scale) between content and style, thereby allowing a user to flexibly experiment with changes in style and content weights. In some implementations, the selective layer conditioning system provides a style-and-content-weight controller whereby a user may provide user input identifying how much of a particular stylization prompt contains style information versus color information.

In some implementations, the selective layer conditioning system automatically determines style and content weights between a text input and an image input. For example, the selective layer conditioning system determines that the image input contains primarily style information and determines the weights accordingly. In some implementations, the selective layer conditioning system generates a digital image based on the automatically determined style and content weights, as a starting point in a design process, whereby a user can further modify the style and content weights to effect changes to the output digital image.

Moreover, in some implementations, the selective layer conditioning system determines a number of timesteps (e.g., denoising iterations) of a diffusion neural network to condition utilizing style-specific information and/or content-specific information. For instance, the selective layer conditioning system determines to condition the first few denoising iterations of the diffusion neural network with style-specific information comprising color information.

The selective layer conditioning system provides a variety of technical advantages relative to existing systems. For example, by conditioning layers and/or denoising iterations of an image generation neural network, the selective layer conditioning system improves accuracy relative to existing systems. Specifically, by conditioning the image generation neural network based on style and content weights of image and text prompts, the selective layer conditioning system generates digital images that more accurately reflect a design intent underlying the image and text prompts. To illustrate, by conditioning layers of the neural network that attend more to style-specific tokens with style-specific prompt information, the selective layer conditioning system increases the style-wise accuracy of the generated digital image. Similarly, by conditioning layers of the neural network that attend more to content-specific tokens with content-specific prompt information, the selective layer conditioning system increases the content-wise accuracy of the generated digital image.

Moreover, in one or more implementations the selective layer conditioning system improves operational flexibility relative to conventional systems. Indeed, as just mentioned, in some implementations the selective layer conditioning system selects which layers to condition for different types of prompts. Moreover, in one or more embodiments, the selective layer conditioning system allows client devices to dynamically modify the particular layers utilized to process particular prompts. Furthermore, the selective layer conditioning system operates with regard to a variety of different types (or modes) of input prompts, such as text and/or image inputs. Thus, in various embodiments, the selective layer conditioning system provides improved functionality and flexibility.

Additionally, in one or more embodiments the selective layer conditioning system improves computational efficiency. Indeed, by controlling which layers and/or denoising iterations of a neural network receive which prompt information, the selective layer conditioning system increases efficiency of implementing computing devices. For example, in one or more embodiments, the selective layer conditioning system achieves content and style adjustments by varying the layers that receive particular prompts without the need for additional/specialized training. To illustrate, in various implementations the selective layer conditioning system avoids additional training, optimization, or encoders for the neural network in generating modified digital images portraying specialized styles, effects, or content.

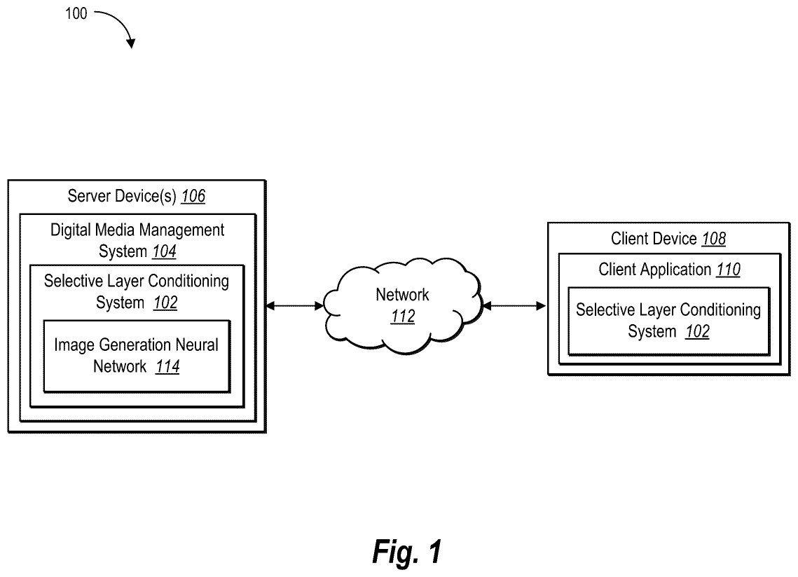

Additional detail will now be provided in relation to illustrative figures portraying example embodiments and implementations of a selective layer conditioning system. For example, FIG. 1 illustrates a system 100 (or environment) in which a selective layer conditioning system 102 operates in accordance with one or more embodiments. As illustrated, the system 100 includes server device(s) 106, a network 112, and a client device 108. As further illustrated, the server device(s) 106 and the client device 108 communicate with one another via the network 112.

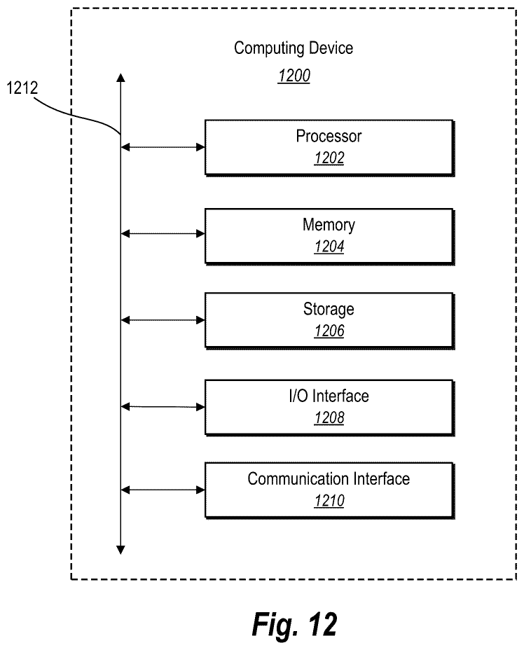

As shown in FIG. 1, the server device(s) 106 includes a digital media management system 104 that further includes the selective layer conditioning system 102. In some embodiments, the selective layer conditioning system 102 generates a digital image in response to one or more text prompts, one or more image prompts, or a combination of one or more text prompts and one or more image prompts. In some embodiments, the selective layer conditioning system 102 utilizes a machine learning model (such as an image generation neural network 114) to generate the digital image. In some embodiments, the selective layer conditioning system 102 selectively conditions layers of the image generation neural network 114 as described herein. In some embodiments, the server device(s) 106 includes, but is not limited to, a computing device (such as explained below with reference to FIG. 12).

In some instances, the selective layer conditioning system 102 receives a request (e.g., from the client device 108) to generate a digital image. For example, the selective layer conditioning system 102 receives an image prompt and a text prompt and generates a digital image in response to the image prompt and the text prompt. Some embodiments of server device(s) 106 perform a variety of functions via the digital media management system 104 on the server device(s) 106. To illustrate, the server device(s) 106 (through the selective layer conditioning system 102 on the digital media management system 104) performs functions such as, but not limited to, obtaining an image prompt, obtaining a text prompt, generating an image vector representation of the image prompt, generating a text vector representation of the text prompt, conditioning one or more layers of a neural network with the image vector representation, conditioning one or more additional layers of the neural network with the text vector representation, and generating a digital image. In some embodiments, the server device(s) 106 selectively conditions layers of the image generation neural network 114 with the image vector representation and/or the text vector representation, and utilizes the image generation neural network 114 to generate the digital image. In some embodiments, the server device(s) 106 trains the image generation neural network 114.

Furthermore, as shown in FIG. 1, the system 100 includes the client device 108. In some embodiments, the client device 108 includes, but is not limited to, a mobile device (e.g., a smartphone, a tablet), a laptop computer, a desktop computer, or any other type of computing device, including those explained below with reference to FIG. 12. Some embodiments of client device 108 perform a variety of functions via a client application 110 on client device 108. For example, the client device 108 (through the client application 110) performs functions such as, but not limited to, obtaining an image prompt, obtaining a text prompt, generating an image vector representation of the image prompt, generating a text vector representation of the text prompt, conditioning one or more layers of a neural network with the image vector representation, conditioning one or more additional layers of the neural network with the text vector representation, and generating a digital image. In some embodiments, the client device 108 selectively conditions layers of the image generation neural network 114 with the image vector representation and/or the text vector representation, and utilizes the image generation neural network 114 to generate the digital image. In some embodiments, the client device 108 trains the image generation neural network 114.

To access the functionalities of the selective layer conditioning system 102 (as described above and in greater detail below), in one or more embodiments, a user interacts with the client application 110 on the client device 108. For example, the client application 110 includes one or more software applications (e.g., to interact with digital images and/or text in accordance with one or more embodiments described herein) installed on the client device 108, such as a digital media management application, an image editing application, and/or an image retrieval application. In certain instances, the client application 110 is hosted on the server device(s) 106. Additionally, when hosted on the server device(s) 106, the client application 110 is accessed by the client device 108 through a web browser and/or another online interfacing platform and/or tool.

As illustrated in FIG. 1, in some embodiments, the selective layer conditioning system 102 is hosted by the client application 110 on the client device 108 (e.g., additionally or alternatively to being hosted by the digital media management system 104 on the server device(s) 106). For example, the selective layer conditioning system 102 performs the neural network layer conditioning techniques described herein on the client device 108. In some implementations, the selective layer conditioning system 102 utilizes the server device(s) 106 to train and implement machine learning models (such as the image generation neural network 114). In one or more embodiments, the selective layer conditioning system 102 utilizes the server device(s) 106 to train machine learning models (such as the image generation neural network 114) and utilizes the client device 108 to implement or apply the machine learning models.

Further, although FIG. 1 illustrates the selective layer conditioning system 102 being implemented by a particular component and/or device within the system 100 (e.g., the server device(s) 106 and/or the client device 108), in some embodiments the selective layer conditioning system 102 is implemented, in whole or in part, by other computing devices and/or components in the system 100. For instance, in some embodiments, the selective layer conditioning system 102 is implemented on another client device. More specifically, in one or more embodiments, the description of (and acts performed by) the selective layer conditioning system 102 are implemented by (or performed by) the client application 110 on another client device.

In some embodiments, the client application 110 includes a web hosting application that allows the client device 108 to interact with content and services hosted on the server device(s) 106. To illustrate, in one or more implementations, the client device 108 accesses a web page or computing application supported by the server device(s) 106. The client device 108 provides input to the server device(s) 106 (e.g., a text prompt, an image prompt). In response, the selective layer conditioning system 102 on the server device(s) 106 performs operations described herein to selectively condition layers of a neural network (e.g., the image generation neural network 114) and utilize the neural network to generate a digital image. The server device(s) 106 provides the output or results of the operations (e.g., the digital image) to the client device 108. As another example, in some implementations, the selective layer conditioning system 102 on the client device 108 performs operations described herein to selectively condition layers of a neural network (e.g., the image generation neural network 114) and utilize the neural network to generate a digital image. The client device 108 provides the output or results of the operations (e.g., the digital image) via a display of the client device 108, and/or transmits the output or results of the operations to another device (e.g., the server device(s) 106 and/or another client device).

Additionally, as shown in FIG. 1, the system 100 includes the network 112. As mentioned above, in some instances, the network 112 enables communication between components of the system 100. In certain embodiments, the network 112 includes a suitable network and may communicate using any communication platforms and technologies suitable for transporting data and/or communication signals, examples of which are described with reference to FIG. 12. Furthermore, although FIG. 1 illustrates the server device(s) 106 and the client device 108 communicating via the network 112, in certain embodiments, the various components of the system 100 communicate and/or interact via other methods (e.g., the server device(s) 106 and the client device 108 communicate directly).

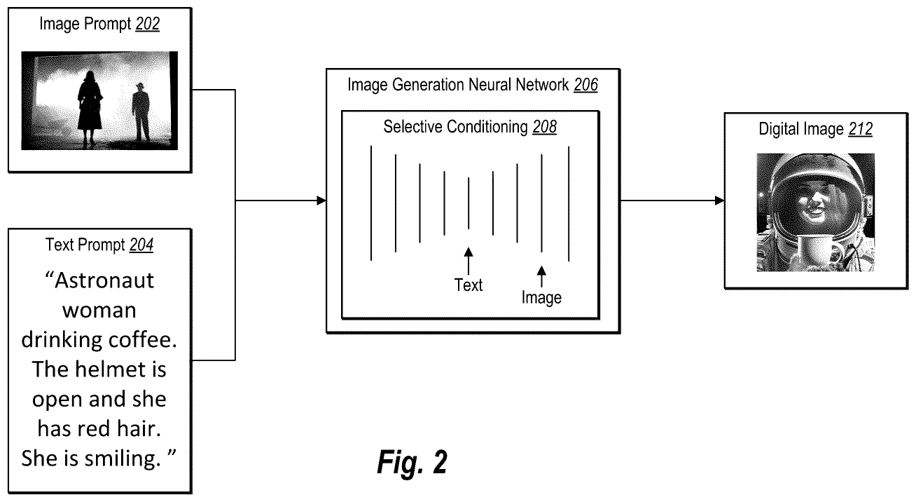

As discussed above, in some embodiments, the selective layer conditioning system 102 selectively conditions layers of a neural network with text and/or image information to generate a digital image. For instance, FIG. 2 illustrates the selective layer conditioning system 102 generating a digital image 212 from an image prompt 202 and a text prompt 204 utilizing an image generation neural network 206 with selective conditioning 208 in accordance with one or more embodiments.

Specifically, FIG. 2 shows the selective layer conditioning system 102 obtaining the image prompt 202. The image prompt 202 includes a digital visual representation (e.g., having a meaning or intent for generating or modifying a digital image). The image prompt 202 can portray a variety of objects or subjects in a variety of formats. For example, the image prompt 202 can include a jpeg, a tiff, a pdf, or some other digital visual media format. Similarly, the image prompt 202 can include a frame of a digital video. The selective layer conditioning system 102 can obtain the image prompt 202 from a variety of sources. For example, in some embodiments the selective layer conditioning system 102 captures the image prompt 202 utilizing a camera device of a client device. In some implementations, the selective layer conditioning system 102 obtains the image prompt 202 from a repository of digital images (e.g., from a cloud storage repository).

As also shown in FIG. 2, the selective layer conditioning system 102 obtains the text prompt 204. The text prompt 204 includes a verbal description (e.g., of a characteristic, feature, or intended modification for a digital image). For example, the text prompt 204 can include a textual description of a desired characteristic of the digital image 212 (e.g., an object to portray in a digital image or a style to be reflected in the digital image). The selective layer conditioning system 102 can identify the text prompt 204 from a variety of different sources. For example, in some implementations, the selective layer conditioning system 102 receives the text prompt 204 based on user interaction (e.g., typing) with a user interface of a client device. In some embodiments, the selective layer conditioning system 102 obtains the text prompt 204 from audio input via a client device. For example, the selective layer conditioning system 102 converts audio input (e.g., speaking) to a textual input utilizing a transcription model.

As shown in FIG. 2, the selective layer conditioning system 102 utilizes an image generation neural network 206 (e.g., the image generation neural network 114) to generate the digital image 212 from the image prompt 202 and the text prompt 204. A neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. For example, a neural network includes a deep neural network, a convolutional neural network, a diffusion neural network, a recurrent neural network (e.g., an LSTM), a graph neural network, a transformer, or a generative adversarial neural network.

In some cases, a neural network includes various layers such as an input layer, one or more hidden layers, and an output layer that each perform tasks for processing data. Moreover, in some embodiments, a neural network includes downsampling layers and upsampling layers for processing image and/or text information. To illustrate, the selective layer conditioning system 102 utilizes an upsampling layer of a neural network to convert a relatively low-resolution vector representation to a higher resolution vector representation. A resolution includes an amount of information (e.g., dimensionality) in a vector representation. To illustrate, a high resolution corresponds to a relatively greater degree of information (e.g., a high dimension layer processing high dimensionality vectors) or detail reflected in a vector representation or a digital visual media item, than another resolution, such as a low resolution. Furthermore, in some embodiments, a neural network includes high-resolution layers and low-resolution layers. For example, the selective layer conditioning system 102 utilizes a low-resolution upsampling layer of a neural network to convert a low-resolution vector representation to a relatively higher resolution vector representation, and a high-resolution upsampling layer of the neural network to convert the relatively higher resolution vector representation to an even higher resolution vector representation.

A diffusion neural network (or diffusional model) refers to a likelihood-based model for image synthesis. In particular, a diffusion model is based on a Gaussian denoising process (e.g., based on a premise that the noises added to the original images are drawn from Gaussian distributions). The denoising process involves predicting the added noises using a neural network (e.g., a convolutional neural network such as UNet). For example, in some implementations, the selective layer conditioning system 102 utilizes a time conditional U-Net, as described by O. Ronneberger, et al. in U-net: Convolutional networks for biomedical image segmentation, MICCAI (3), Vol. 9351 of Lecture Notes in Computer Science, p. 234-241 (2015), which is incorporated by reference herein in its entirety. During training, Gaussian noise is iteratively added to a digital image in a sequence of steps (or iterations) to generate a noise map (or noise representation). The neural network is trained to recreate the digital image by reversing the noising process. In particular, the neural network utilizes a plurality of steps (or iterations) to iteratively denoise the noise representation. The diffusion neural network can thus generate digital images from noise representations.

In some implementations, the selective layer conditioning system 102 utilizes selective conditioning 208 for the image generation neural network 206 to generate the digital image 212. To illustrate, the selective layer conditioning system 102 utilizes (e.g., for a diffusion neural network) a conditioning mechanism to condition the denoising layers for adding edits or modifications in generating a digital image from the noise representation. In conditional settings, diffusion models can be augmented with classifier or non-classifier guidance. Diffusion models can be conditioned on texts, images, or both. Moreover, diffusion models/neural networks include latent diffusion models. Latent diffusion models are diffusion models that utilize latent representations (e.g., rather than pixels). For example, a latent diffusion model includes a diffusion model trained and sampled from a latent space (e.g., trained by noising and denoising encodings or embeddings in a latent space rather than noising and denoising pixels). The selective layer conditioning system 102 can utilize a variety of diffusion models. For example, in one or more embodiments, the selective layer conditioning system 102 utilizes a diffusion model (or diffusion neural network) as described by Robin Rombach, Andreas Blattmann, Dominik Lorenz, Patrick Esser, and Bjorn Ommer in High-resolution image synthesis with latent diffusion models, in Proceedings of the IEEE/CVF Conference on Computer Vision and Pattern Recognition, pages 10684-10695, 2022. Similarly, in some implementations, the selective layer conditioning system 102 utilizes a diffusion neural network as described by Jiaming Song, et al. in Denoising diffusion implicit models, in ICLR, 2021, which is incorporated by reference in its entirety herein.

As mentioned, in some implementations, the selective layer conditioning system 102 utilizes selective conditioning 208 to condition layers of a neural network. For instance, the selective layer conditioning system 102 conditions one or more layers of the image generation neural network 206 with text information and one or more additional layers of the image generation neural network 206 with image information. To illustrate, in some embodiments, the selective layer conditioning system 102 conditions a low-resolution upsampling layer of the neural network with the text prompt 204 and a high-resolution upsampling layer of the neural network with the image prompt 202. More particularly, in some embodiments, the selective layer conditioning system 102 conditions the low-resolution upsampling layer with the text prompt 204 and without the image prompt 202. Similarly, in some embodiments, the selective layer conditioning system 102 conditions the high-resolution upsampling layer with the image prompt 202 and without the text prompt 204. In other words, in some implementations, the selective layer conditioning system 102 determines to condition one or more layers with a first prompt and without a second prompt, thereby controlling which layers receive which prompts. By selectively conditioning the layers of the neural network, in some implementations, the selective layer conditioning system 102 improves the correlation of the digital image 212 with a design intent underlying the image prompt 202 and the text prompt 204.

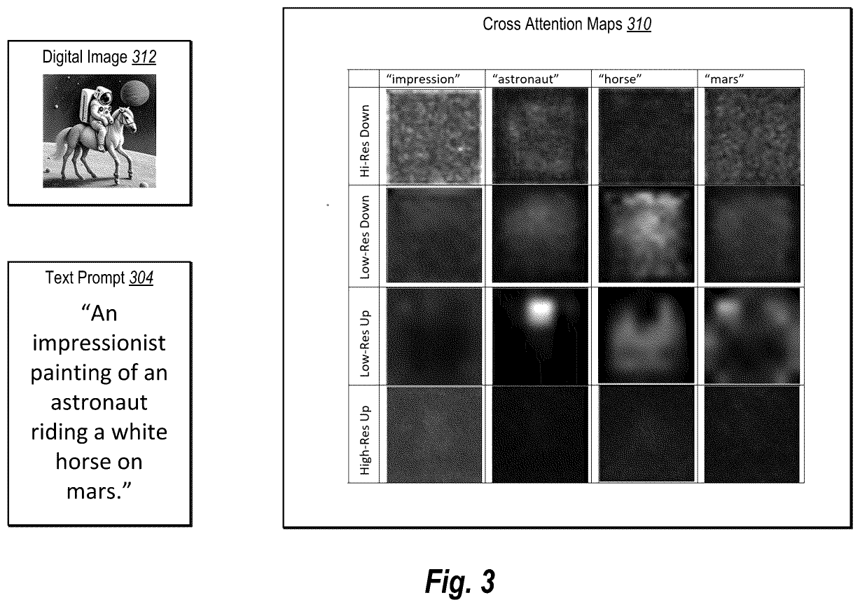

FIG. 3 illustrates the selective layer conditioning system 102 generating cross attention maps for a digital image and a text prompt in accordance with one or more embodiments. More particularly, FIG. 3 shows the selective layer conditioning system 102 displaying cross attention maps for a digital image 312 with respect to portions of a text prompt 304.

Specifically, in some implementations, the selective layer conditioning system 102 utilizes cross attention to determine relationships between two stylization prompts (e.g., an image and a text string). In some embodiments, the selective layer conditioning system 102 combines a query with a key, utilizes a softmax operation on the combined query and key, and combines the result with a value to determine a cross attention metric. In some implementations, the selective layer conditioning system 102 performs this operation pixel-wise for the digital image 312 to generate a cross attention map for the digital image 312 with respect to a token of the text prompt 304. For example, in some embodiments, the selective layer conditioning system 102 tokenizes the text prompt 304 (e.g., by generating a text vector representation) and the digital image 312 (e.g., by generating an image vector representation). In some embodiments, by way of example and not limitation, the selective layer conditioning system 102 generates one hundred and twenty eight text tokens from the text prompt 304 and one image token from the digital image 312.

FIG. 3 shows example cross attention maps 310 based on the digital image 312 and the text prompt 304. As shown in the cross attention maps 310, in some embodiments, the selective layer conditioning system 102 gives relatively high attention to style-specific tokens at high-resolution layers of a neural network, while giving relatively high attention to content-specific tokens at low-resolution layers of the neural network. For example, the word “impression,” which connotes style (rather than content) receives the most attention in the high-resolution layers (in both downsampling and upsampling layers), as shown in FIG. 3 by the lighter attention maps for the high-resolution layers under the header “impression.” By contrast, the words “astronaut,” “horse,” and “Mars,” which connote content (rather than style) each receive the most attention in the low-resolution layers, as shown in FIG. 3 by the lighter portions of the attention maps for the low-resolution layers under the headers “astronaut,” “horse,” and “Mars.”

In some implementations, the selective layer conditioning system 102 leverages the relatively high attention given to style-specific tokens in high-resolution layers, and the relatively high attention given to content-specific tokens in low-resolution layers, by conditioning the high-and low-resolution layers respectively with style-and content-specific tokens, as described herein.

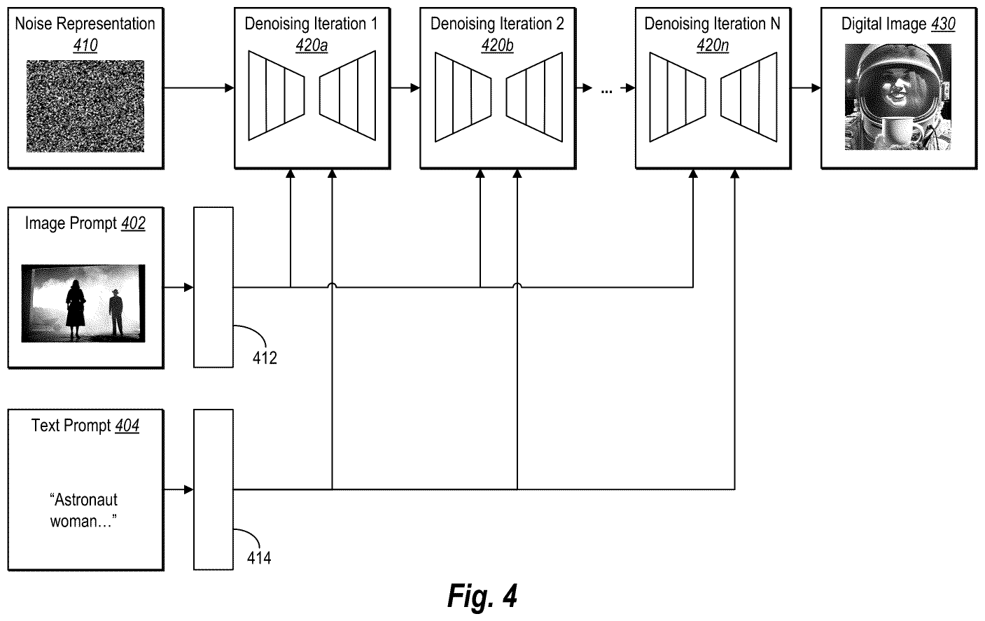

As discussed, in some embodiments, the selective layer conditioning system 102 generates a digital image by conditioning denoising iterations of a diffusion neural network. For instance, FIG. 4 illustrates the selective layer conditioning system 102 utilizing conditioning for a diffusion neural network to generate a digital image from a noise representation, an image prompt, and a text prompt in accordance with one or more embodiments.

Specifically, FIG. 4 shows the selective layer conditioning system 102 obtaining an image prompt 402 and a text prompt 404. In some implementations, the selective layer conditioning system 102 generates vector representations from the prompts. A vector representation includes a numerical representation of features of an image, a text string, or a combination of an image and a text string. For example, an image vector representation includes a feature map, feature vector, or other numerical representation of latent features of a digital image. To illustrate, in some embodiments, the selective layer conditioning system 102 generates an image vector representation 412 by processing the image prompt 402 through one or more layers of a neural network (e.g., an image encoder). Moreover, a text vector representation includes a feature token, feature vector, or other numerical representation of features of a text string (e.g., features suggesting a semantic connotation or meaning of the text string). To illustrate, in some embodiments, the selective layer conditioning system 102 generates a text vector representation 414 by processing the text prompt 404 through one or more layers of a neural network (e.g., a text encoder).

Additionally, FIG. 4 shows the selective layer conditioning system 102 obtaining a noise representation 410. A noise representation includes a noise map or a random distribution of pixels in a digital image. In some implementations, the selective layer conditioning system 102 utilizes the noise representation 410 to generate a digital image 430 utilizing a denoising process. For example, the selective layer conditioning system 102 utilizes a series of denoising iterations 420a-420n (or denoising timesteps) of a diffusion neural network.

To illustrate, the selective layer conditioning system 102 utilizes a first denoising iteration 420a by processing the noise representation 410 through a neural network in the first denoising iteration 420a. In some embodiments, the selective layer conditioning system 102 conditions layers of the neural network in the first denoising iteration 420a with the image vector representation 412 and/or the text vector representation 414. For example, as described above and with additional detail below, the selective layer conditioning system 102 conditions a first layer of the neural network of the first denoising iteration 420a with the image vector representation 412 of the image prompt 402, and conditions a second layer of the neural network of the first denoising iteration 420a with the text vector representation 414 of the text prompt 404.

More particularly, in some implementations, the selective layer conditioning system 102 conditions the second layer of the neural network of the first denoising iteration 420a with the text vector representation 414 and without the image vector representation 412. Similarly, in some embodiments, the selective layer conditioning system 102 conditions the first layer of the neural network of the first denoising iteration 420a with the image vector representation 412 and without the text vector representation 414. Alternatively, in some embodiments, the selective layer conditioning system 102 conditions the first layer of the neural network of the first denoising iteration 420a with the image vector representation 412 and with the text vector representation 414.

In some embodiments, the selective layer conditioning system 102 utilizes the first denoising iteration 420a to generate an additional noise representation from the noise representation 410. For example, the selective layer conditioning system 102 constructs the additional noise representation from the noise representation 410 utilizing a reverse diffusion process that removes at least some of the random noise contained in the noise representation 410.

In some embodiments, the selective layer conditioning system 102 repeats the denoising process though successive iterations. For instance, the selective layer conditioning system 102 utilizes a second denoising iteration 420b to generate a further noise representation from the additional noise representation. For example, the selective layer conditioning system 102 utilizes a neural network of the second denoising iteration 420b conditioned with the image vector representation 412 and/or the text vector representation 414 to generate the further noise representation.

As the selective layer conditioning system 102 iteratively repeats this denoising process, in some implementations, the noise representations successively contain less random noise, until the selective layer conditioning system 102 generates the digital image 430. For instance, the selective layer conditioning system 102 utilizes a final denoising iteration 420n to generate the digital image 430 from a preceding noise representation, the image vector representation 412, and the text vector representation 414. More particularly, in some implementations, the selective layer conditioning system 102 utilizes a neural network of the final denoising iteration 420n to generate the digital image 430, similarly to the description above of utilizing the neural networks of the preceding denoising iterations.

In some embodiments, the selective layer conditioning system 102 determines a number of denoising iterations of the diffusion neural network to condition utilizing the image vector representation 412 and/or the text vector representation 414. To illustrate, in some implementations, the selective layer conditioning system 102 determines that the image vector representation 412 contains important color information that should influence the digital image 430. In some cases, the diffusion neural network captures color information in the first few denoising iterations. Thus, in some implementations, the selective layer conditioning system 102 determines a number of initial denoising iterations to condition utilizing the image vector representation 412. For example, the selective layer conditioning system 102 processes the image vector representation 412 through these initial denoising iterations, and omits the image vector representation 412 from at least some of the remaining denoising iterations.

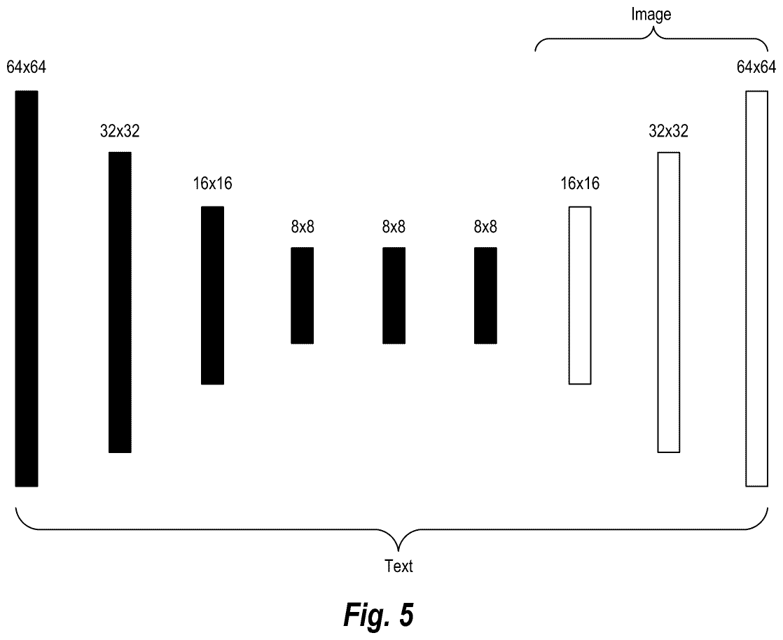

As discussed above, in some embodiments, the selective layer conditioning system 102 selectively conditions layers of a neural network with image information and/or text information. For instance, FIG. 5 illustrates the selective layer conditioning system 102 conditioning layers of a neural network in accordance with one or more embodiments.

Specifically, FIG. 5 shows the selective layer conditioning system 102 conditioning high-resolution upsampling layers of a neural network with an image vector representation of an image prompt, and conditioning low-resolution upsampling layers of the neural network with a text vector representation of a text prompt, without the image vector representation. For example, the selective layer conditioning system 102 conditions high-resolution upsampling layers (e.g., 16×16, 32×32, and 64×64) with the image vector representation, and conditions a low-resolution upsampling layer (e.g., 8×8) with the text vector representation, wherein the high-resolution upsampling layers have a higher resolution (i.e., process image and/or text information at a higher resolution) than the low-resolution upsampling layer.

Additionally, FIG. 5 shows the selective layer conditioning system 102 conditioning downsampling layers of the neural network with the text vector representation without the image vector representation. For example, the selective layer conditioning system 102 conditions both high-resolution and low-resolution downsampling layers of the neural network with the text vector representation. In some embodiments, the selective layer conditioning system 102 omits the image vector representation from all downsampling layers of the neural network.

Furthermore, FIG. 5 shows the selective layer conditioning system 102 conditioning the high-resolution upsampling layers of the neural network with the text vector representation (e.g., in addition to with the image vector representation). In particular, in some embodiments, the selective layer conditioning system 102 combines the text vector representation and the image vector representation to condition one or more layers of the neural network. For example, in some implementations, the selective layer conditioning system 102 concatenates the text vector representation and the image vector representation to condition one or more layers.

In some embodiments, the selective layer conditioning system 102 determines a number of high-resolution layers of a neural network to condition with the image vector representation and/or the text vector representation. For instance, FIG. 5 shows the selective layer conditioning system 102 determining to condition the 16×16, 32×32, and 64×64 upsampling layers of the neural network with the image vector representation. Alternatively, for example, the selective layer conditioning system 102 determines to condition the 32×32 and 64×64 upsampling layers with the image vector representation, but not the 16×16 upsampling layer.

Similarly, in some implementations, the selective layer conditioning system 102 determines a number of low-resolution layers of a neural network to condition with the image vector representation and/or the text vector representation. More particularly, in some implementations, the selective layer conditioning system 102 determines a number of low-resolution layers of the neural network to condition with the text vector representation and without the image vector representation. For instance, FIG. 5 shows the selective layer conditioning system 102 determining to condition the 8×8 upsampling layer of the neural network with the text vector representation without the image vector representation. Alternatively, for example, the selective layer conditioning system 102 determines to condition the 8×8, 16×16, and/or 32×32 upsampling layers with the text vector representation without the image vector representation.

The depiction and description herein of particular resolutions of neural network layers is for illustrative purposes, and is not to limit the disclosure. For example, in some embodiments, the selective layer conditioning system 102 conditions neural network layers having other resolutions (e.g., 128×128, 256×256, etc.).

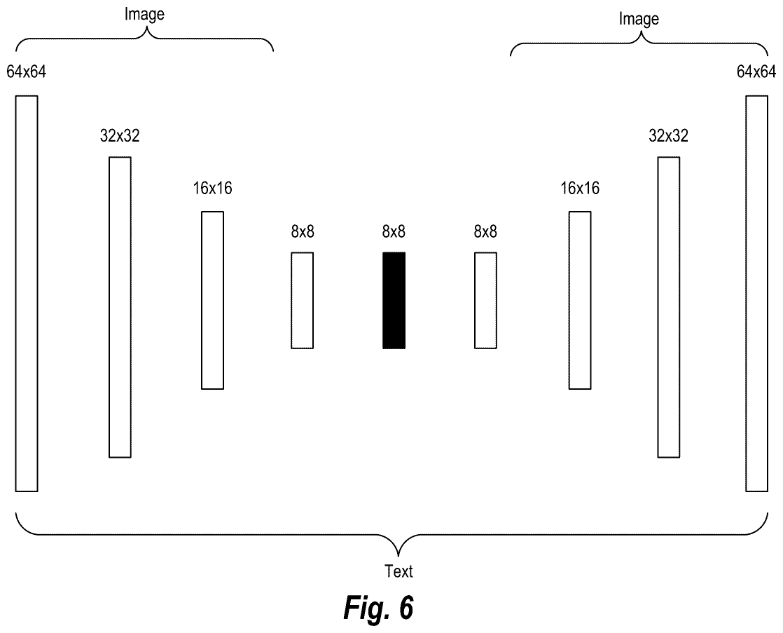

FIG. 6 illustrates an alternative example of layer conditioning. In particular, FIG. 6 shows the selective layer conditioning system 102 conditioning layers of a neural network in accordance with one or more embodiments.

Specifically, FIG. 6 shows the selective layer conditioning system 102 conditioning high-resolution downsampling layers and high-resolution upsampling layers of a neural network with an image vector representation of an image prompt. Furthermore, FIG. 6 shows the selective layer conditioning system 102 conditioning a low-resolution layer of the neural network with a text vector representation of a text prompt without the image vector representation. For example, the selective layer conditioning system 102 conditions high-resolution downsampling and upsampling layers (e.g., 16×16, 32×32, and 64×64) with the image vector representation, and conditions a low-resolution layer (e.g., 8×8) with the text vector representation without the image vector representation. Additionally, in some embodiments, the selective layer conditioning system 102 conditions the high-resolution downsampling and upsampling layers with the image vector representation combined with the text vector representation.

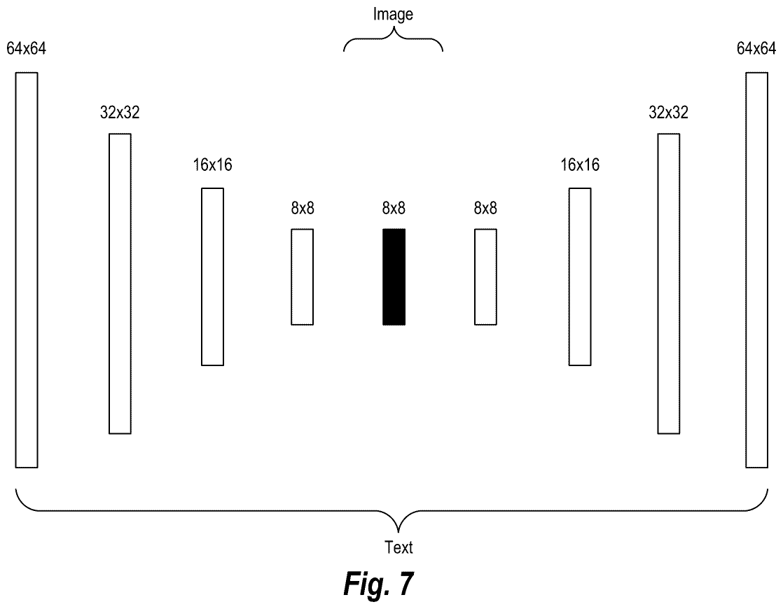

FIG. 7 illustrates another alternative example of layer conditioning. In particular, FIG. 7 shows the selective layer conditioning system 102 conditioning layers of a neural network in accordance with one or more embodiments.

Specifically, FIG. 7 shows the selective layer conditioning system 102 conditioning a low-resolution layer of a neural network with an image vector representation of an image prompt. Furthermore, FIG. 7 shows the selective layer conditioning system 102 conditioning high-resolution downsampling layers and high-resolution upsampling layers of the neural network with a text vector representation of a text prompt, without the image vector representation. For example, the selective layer conditioning system 102 conditions a low-resolution layer (e.g., 8×8) with the image vector representation, and conditions high-resolution downsampling and upsampling layers (e.g., 16×16, 32×32, and 64×64) with the text vector representation and without the image vector representation. In some implementations, the selective layer conditioning system 102 conditions a low-resolution upsampling layer (e.g., 8×8) of the neural network with the image vector representation. Additionally, in some embodiments, the selective layer conditioning system 102 conditions the low-resolution layer with the text vector representation combined with the image vector representation.

Although FIGS. 5-7 illustrate conditioning particular layers utilizing particular text/image prompt combinations, it will be appreciated that the selective layer conditioning system 102 can utilize other combinations of prompts and layers. For example, in some embodiments, the selective layer conditioning system 102 conditions a first subset of downsampling layers utilizing an image prompt (e.g., the first 1 or 2 high-resolution downsampling layers) and a second subset of downsampling layers utilizing a text prompt. Similarly, in some implementations, the selective layer conditioning system 102 conditions all downsampling layers utilizing a text prompt and all upsampling layers utilizing an image prompt (or vice versa).

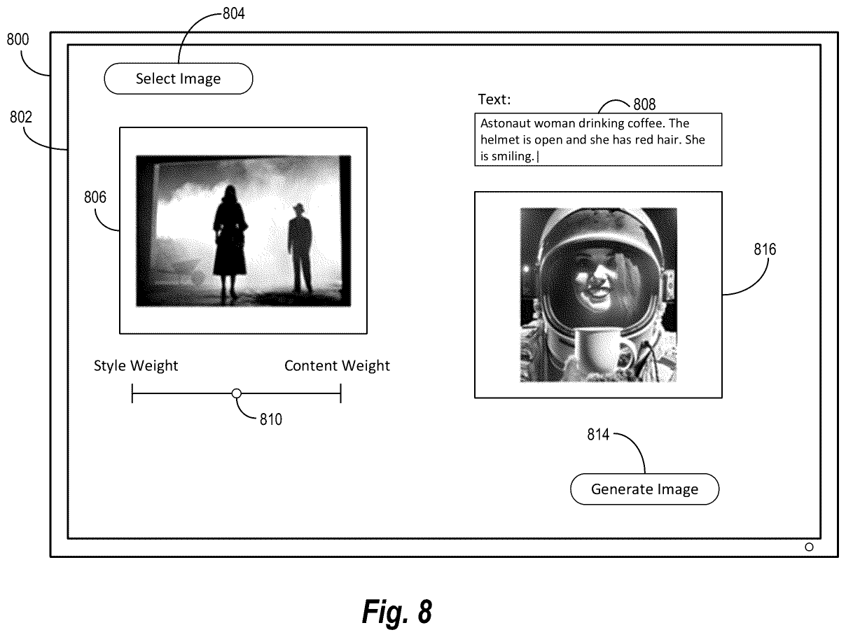

As mentioned, in some embodiments, the selective layer conditioning system 102 provides a user interface via a client device for providing stylization prompts (image prompts and text prompts) and control inputs to indicate weights for style and content information contained within the stylization prompts. For instance, FIG. 8 illustrates a user interface for controlling the style and content weights of an image prompt and a text prompt via a style-and-content-weight controller, in accordance with one or more embodiments.

Specifically, FIG. 8 shows a screen of a client device 800 displaying a user interface 802. The user interface 802 includes a variety of user interface elements. In particular, the user interface 802 includes a select image element 804. Based on user interaction with the select image element 804, the selective layer conditioning system 102 can provide additional user interface elements for selecting an image prompt. To illustrate, the selective layer conditioning system 102 can provide a list of digital images stored on the client device 800 or a list of digital images stored remotely via a cloud repository. Similarly, based on user interaction with the select image element 804, the selective layer conditioning system 102 can provide an option to capture a digital image utilizing a camera of the client device 800.

As shown in FIG. 8, based on user interaction with the select image element 804, the selective layer conditioning system 102 identifies an image prompt 806. Moreover, the selective layer conditioning system 102 provides the image prompt 806 for display via the user interface 802. In addition, the user interface 802 also includes an edit text element for entering a text prompt 808. The selective layer conditioning system 102 can receive the image prompt 806 and the text prompt 808 for conditioning a neural network, as described above. Although illustrated as a user interface element for receiving textual inputs, the edit text element can include a variety of user interface elements, including a selectable element for initiating audio input.

As also shown in FIG. 8, the user interface 802 includes a style-and-content-weight controller 810. Based on user interaction with the style-and-content-weight controller 810, the selective layer conditioning system 102 can determine a weight parameter indicating a relative degree for how much the image prompt 806 and how much the text prompt 808 contribute, respectively, to a desired style and a desired content for generating a digital image.

In some implementations, the selective layer conditioning system 102 utilizes the weight parameter to determine a number or amount of denoising iterations of a diffusion neural network to condition utilizing the image prompt 806 and/or the text prompt 808. For example, the selective layer conditioning system 102 determines to condition the first few denoising iterations with the image prompt 806, and to omit the image prompt 806 from some of the remaining denoising iterations. As another example, the selective layer conditioning system 102 determines to condition all denoising iterations with the text prompt 808, but only some (e.g., the final twenty percent) of the denoising iterations with the image prompt 806. Thus, in some embodiments, the selective layer conditioning system 102 determines, based on user interaction with the style-and-content-weight controller 810 (or a separate user interface element/controller), a number of denoising iterations to condition utilizing the image prompt 806 (or an image vector representation of the image prompt 806) and/or the text prompt 808 (or a text vector representation of the text prompt 808).

Moreover, in some implementations, the selective layer conditioning system 102 utilizes the weight parameter to determine a number or amount of layers within a neural network to condition utilizing the image prompt 806 and/or the text prompt 808. For example, within a particular denoising iteration of a diffusion neural network, the selective layer conditioning system 102 determines to condition a number (e.g., the final ten percent) of upsampling layers with the image prompt 806, and to omit the image prompt 806 from the other upsampling layers. As another example, the selective layer conditioning system 102 determines to condition a number of low-resolution layers of a neural network with the text prompt 808, and a number of high-resolution layers of the neural network with the image prompt 806. Thus, in some embodiments, the selective layer conditioning system 102 determines, based on user interaction with the style-and-content-weight controller 810, which layers of the neural network to condition utilizing the image prompt 806 (or an image vector representation of the image prompt 806), and which layers of the neural network to condition utilizing the text prompt 808 (or a text vector representation of the text prompt 808).

In some implementations, the selective layer conditioning system 102 provides multiple style-and-content-weight controllers for display via the user interface 802. For instance, in some embodiments, the selective layer conditioning system 102 provides a style-and-content-weight controller for the image prompt 806 and another style-and-content-weight controller for the text prompt 808. Thus, in some implementations, the selective layer conditioning system 102 offers a user the option to independently select a weight between style and content for the image prompt 806 and another weight between style and content for the text prompt 808.

Although illustrated in FIG. 8 as a slider element, the style-and-content-weight controller 810 can include a variety of different user interface elements. In some embodiments, the selective layer conditioning system 102 can identify the weight parameter without providing a style-and-content-weight controller visibly in the user interface. For example, by selecting a portion of the screen closer to the image prompt 806, the selective layer conditioning system 102 can emphasize the image prompt 806 in the weight parameter. In some embodiments, the selective layer conditioning system 102 utilizes a default assignment for the image prompt 806 and the text prompt 808 (e.g., associating the image prompt 806 as primarily indicating content and the text prompt 808 as primarily indicating style, or vice versa).

Furthermore, FIG. 8 shows the user interface 802 including a generate image element 814. Based on user interaction with the generate image element 814, in some implementations, the selective layer conditioning system 102 generates a digital image 816 based on the image prompt 806 and the text prompt 808. Specifically, the selective layer conditioning system 102 determines a weight parameter based on user interaction with the style-and-content-weight controller 810. The selective layer conditioning system 102 generates the digital image 816 based on the image prompt 806, the text prompt 808, and the weight parameter, as described previously.

Moreover, in some embodiments, the selective layer conditioning system 102 generates the digital image 816 without a generate image element. For example, in response to selection of an image prompt and a text prompt, the selective layer conditioning system 102 automatically generates the digital image 816. For example, if the client device captures an image and the selective layer conditioning system 102 detects an audio input (e.g., “I wish that image showed a tropical beach instead of a snowdrift”), the selective layer conditioning system 102 can automatically generate the digital image 816 that transforms the captured image based on the audio input.

Additionally, in some implementations, the selective layer conditioning system 102 iteratively generates digital images as the selective layer conditioning system 102 receives additional user interactions via the user interface 802. For example, in response to selection of a different (or additional) image prompt, selection of a different (or additional) text prompt, and/or selection of a different weight parameter, the selective layer conditioning system 102 generates an additional digital image and provides the additional digital image for display via the user interface 802.

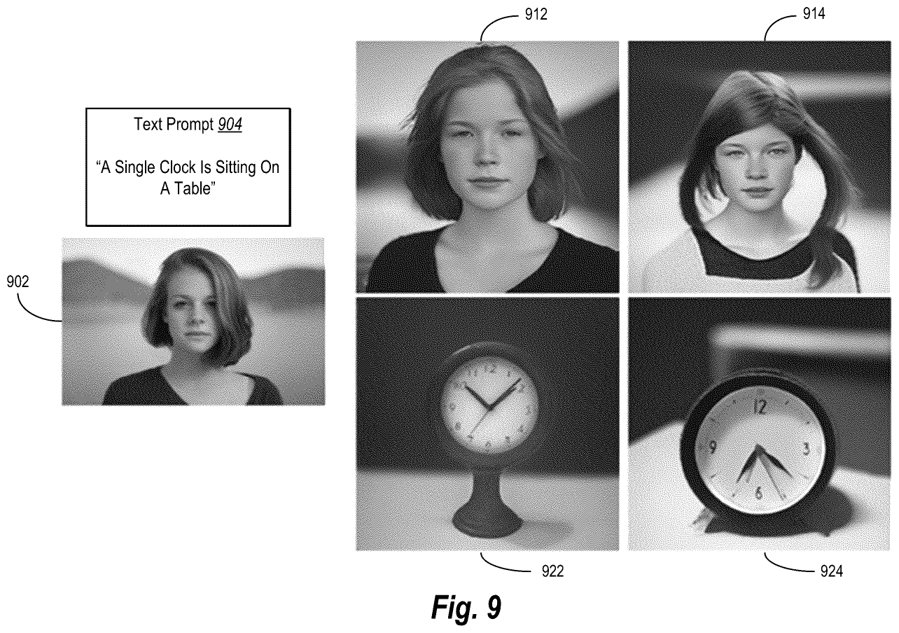

As discussed above, in some embodiments, the selective layer conditioning system 102 generates a digital image based on stylization prompts. For instance, FIG. 9 illustrates example outputs of the selective layer conditioning system 102 and conventional systems according to various conditional settings in accordance with one or more embodiments.

Specifically, FIG. 9 shows stylization prompts: an image prompt 902 and a text prompt 904. In the example of FIG. 9, the image prompt 902 is very content “content heavy,” in that the image prompt 902 is focused on a girl as a subject of the image. Moreover, the text prompt 904 is also very “content heavy,” in that the text asks for a single clock sitting on a table. The text prompt 904 is generally devoid of style information, in that it does not ask for a particular style for a generated digital image. Thus, an intent of the stylization prompts in FIG. 9 is to generate a digital image depicting a clock on a table, with style information (rather than content information) of the image prompt 902 influencing the generated digital image.

FIG. 9 illustrates multiple digital images based on various conditional settings. For example, the digital image 912 results from utilizing a conventional approach with uniform conditioning (i.e., without iteration-wise conditioning and without layer-wise conditioning). In this example, the digital image 912 depicts a girl as a subject with very similar style to the image prompt 902. Thus, the digital image 912 is very similar (in both content and style) to the image prompt 902, and the text prompt 904 played very little role (or no role) in the generation of the digital image 912.

FIG. 9also illustrates a digital image 914 generated without layer-wise conditioning. In particular, the digital image 914 reflects conditioning the first twenty percent of diffusion iterations with only the text prompt 904, and the remaining eighty percent of diffusion iterations with both the text prompt 904 and the image prompt 902. In this example, the digital image 914 depicts a girl as a subject, but some of the text prompt 904 is influencing the generation of the digital image 914. For example, the girl's hair resembles the shape of a clock, and the background looks somewhat like a table.

As shown in FIG. 9, the selective layer conditioning system 102 generates a digital image 922 using layer-wise conditioning (but no iteration-wise conditioning). In particular, the selective layer conditioning system 102 conditions layers of the neural network of each diffusion iteration (e.g., by conditioning the high-resolution upsampling layers with the image prompt 902 and the text prompt 904, while conditioning the other layers with only the text prompt 904). In this example, the digital image 922 depicts a single clock sitting on a table. Moreover, the digital image 922 has some of the style of the image prompt 902. Specifically, the digital image 922 contains a similar color scheme as to the image prompt 902, such as pastel blues, cream, and mahogany. Thus, with layer-wise conditioning, the selective layer conditioning system 102 accurately generates a digital image that reflects a design intent of the stylization prompts (e.g., accurately portrays the text prompt 904 with the style illustrated in the image prompt 902).

As additionally shown in FIG. 9, the selective layer conditioning system 102 generates a digital image 924 using both iteration-wise conditioning and layer-wise conditioning. In particular, the selective layer conditioning system 102 conditions the first twenty percent of diffusion iterations with only the text prompt 904, and the remaining eighty percent of diffusion iterations with both the text prompt 904 and the image prompt 902. Additionally, the selective layer conditioning system 102 conditions layers of the neural network of each diffusion iteration (e.g., by conditioning the high-resolution upsampling layers with the image prompt 902 and the text prompt 904, while conditioning the other layers with only the text prompt 904). In this example, the digital image 924 depicts a single clock sitting on a table. Moreover, the digital image 924 has some of the style of the image prompt 902. Specifically, the digital image 924 contains similar colors as the image prompt 902, such as cream, brown, and dark blue. Thus, with layer-wise conditioning (in isolation or in combination with iteration-wise conditioning), the selective layer conditioning system 102 can flexibly generate a digital image that reflects different design intents of stylization prompts.

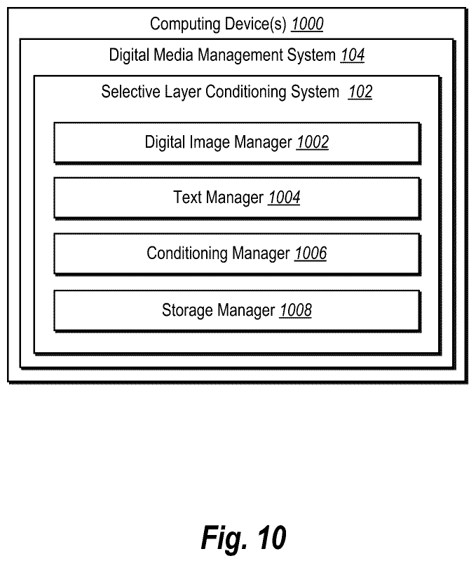

Turning now to FIG. 10, additional detail will be provided regarding components and capabilities of one or more embodiments of the selective layer conditioning system 102. In particular, FIG. 10 illustrates an example selective layer conditioning system 102 executed by a computing device(s) 1000 (e.g., the server device(s) 106 or the client device 108). As shown by the embodiment of FIG. 10, the computing device(s) 1000 includes or hosts the digital media management system 104 and/or the selective layer conditioning system 102. Furthermore, as shown in FIG. 10, the selective layer conditioning system 102 includes a digital image manager 1002, a text manager 1004, a conditioning manager 1006, and a storage manager 1008.

As shown in FIG. 10, the selective layer conditioning system 102 includes a digital image manager 1002. In some implementations, the digital image manager 1002 obtains an image prompt and generates an image vector representation from the image prompt. In some implementations, the digital image manager 1002 utilizes a neural network (e.g., the image generation neural network 114) to generate a digital image.

In addition, as shown in FIG. 10, the selective layer conditioning system 102 includes a text manager 1004. In some implementations, the text manager 1004 obtains a text prompt and generates a text vector representation from the text prompt.

Moreover, as shown in FIG. 10, the selective layer conditioning system 102 includes a conditioning manager 1006. In some implementations, the conditioning manager 1006 conditions one or more layers of a neural network (e.g., the image generation neural network 114) with an image vector representation of an image prompt, as described herein. In some implementations, the conditioning manager 1006 conditions one or more additional layers of the neural network with a text vector representation of a text prompt, as described herein. In some implementations, the conditioning manager 1006 determines a number of low-resolution layers of the neural network to condition with a first vector representation of a first prompt (e.g., the image prompt or the text prompt) and a number of high-resolution layers of the neural network to condition with a second vector representation of a second prompt (e.g., the text prompt or the image prompt). In some implementations, the conditioning manager 1006 determines a number of denoising iterations of a diffusion neural network to condition utilizing the first vector representation.

Furthermore, as shown in FIG. 10, the selective layer conditioning system 102 includes a storage manager 1008. In some implementations, the storage manager 1008 stores information (e.g., via one or more memory devices) on behalf of the selective layer conditioning system 102. For example, the storage manager 1008 includes image prompts (e.g., digital images), text prompts (e.g., text strings), vector representations, and/or generated digital images. Additionally, in some implementations, the storage manager 1008 stores parameters of one or more machine learning models, including the image generation neural network 114. For example, the storage manager 1008 stores parameters of neural networks of various denoising iterations of a diffusion neural network. Furthermore, in some implementations, the storage manager 1008 stores identifying information for selected layers and/or selected denoising iterations to condition with one or more vector representations, as described herein.

Each of the components 1002-1008 of the selective layer conditioning system 102 can include software, hardware, or both. For example, the components 1002-1008 can include one or more instructions stored on a computer-readable storage medium and executable by processors of one or more computing devices, such as a client device or server device. When executed by the one or more processors, the computer-executable instructions of the selective layer conditioning system 102 can cause the computing device(s) to perform the methods described herein. Alternatively, the components 1002-1008 can include hardware, such as a special purpose processing device to perform a certain function or group of functions. Alternatively, the components 1002-1008 of the selective layer conditioning system 102 can include a combination of computer-executable instructions and hardware.

Furthermore, the components 1002-1008 of the selective layer conditioning system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1002-1008 may be implemented as a stand-alone application, such as a desktop or mobile application. Furthermore, the components 1002-1008 may be implemented as one or more web-based applications hosted on a remote server. The components 1002-1008 may also be implemented in a suite of mobile device applications or “apps.” To illustrate, the components 1002-1008 may be implemented in an application, including but not limited to Adobe After Effects, Adobe Creative Cloud, Adobe Express, Adobe Illustrator, Adobe Photoshop, and Adobe Sensei. The foregoing are either registered trademarks or trademarks of Adobe in the United States and/or other countries.

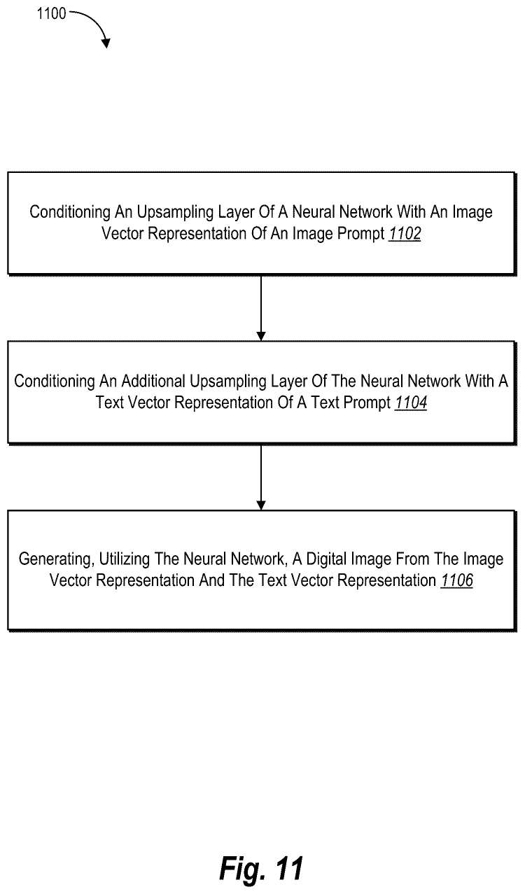

FIGS. 1-10, the corresponding text, and the examples provide a number of different methods, systems, devices, and non-transitory computer-readable media of the selective layer conditioning system 102. In addition to the foregoing, one or more embodiments can also be described in terms of flowcharts comprising acts for accomplishing a particular result, as shown in FIG. 11. FIG. 11 may be performed with more or fewer acts. Further, the acts may be performed in differing orders. Additionally, the acts described herein may be repeated or performed in parallel with one another or parallel with different instances of the same or similar acts.

As mentioned, FIG. 11 illustrates a flowchart of a series of acts 1100 for selectively conditioning layers of a neural network and generating a digital image in accordance with one or more implementations. While FIG. 11 illustrates acts according to one implementation, alternative implementations may omit, add to, reorder, and/or modify any of the acts shown in FIG. 11. The acts of FIG. 11 can be performed as part of a method. Alternatively, a non-transitory computer-readable medium can comprise instructions that, when executed by one or more processors, cause a computing device to perform the acts of FIG. 11. In some implementations, a system performs the acts of FIG. 11.

As shown in FIG. 11, the series of acts 1100 includes an act 1102 of conditioning an upsampling layer of a neural network with an image vector representation of an image prompt, an act 1104 of conditioning an additional upsampling layer of the neural network with a text vector representation of a text prompt, and an act 1106 of generating, utilizing the neural network, a digital image from the image vector representation and the text vector representation.

In particular, in some implementations, the act 1102 includes conditioning an upsampling layer of a neural network with an image vector representation of an image prompt, the act 1104 includes conditioning an additional upsampling layer of the neural network with a text vector representation of a text prompt without the image vector representation of the image prompt, and the act 1106 includes generating, utilizing the neural network, a digital image from the image vector representation and the text vector representation. Additionally, in some implementations, the series of acts 1100 includes receiving the text prompt and the image prompt for generating the digital image.

For example, in some implementations, the series of acts 1100 includes conditioning the upsampling layer of the neural network by conditioning a high-resolution upsampling layer of the neural network with the image vector representation of the image prompt, wherein the high-resolution upsampling layer has a higher resolution than a low-resolution upsampling layer of the neural network. Moreover, in some implementations, the series of acts 1100 includes conditioning the additional upsampling layer of the neural network by conditioning the low-resolution upsampling layer with the text vector representation of the text prompt without the image vector representation of the image prompt. Furthermore, in some implementations, the series of acts 1100 includes conditioning the high-resolution upsampling layer of the neural network with the text vector representation of the text prompt. To illustrate, the series of acts 1100 includes conditioning the upsampling layer of the neural network by conditioning a high-resolution upsampling layer of the neural network with the image vector representation of the image prompt; and conditioning the additional upsampling layer of the neural network by conditioning a low-resolution upsampling layer of the neural network with the text vector representation of the text prompt, wherein the high-resolution upsampling layer has a higher resolution than the low-resolution upsampling layer.

In addition, in some implementations, the series of acts 1100 includes conditioning a plurality of downsampling layers of the neural network with the text vector representation of the text prompt. For example, the series of acts 1100 includes conditioning a plurality of downsampling layers of the neural network with the text vector representation of the text prompt without the image vector representation of the image prompt.

Moreover, in some implementations, the series of acts 1100 includes generating, utilizing the neural network, the digital image from the image vector representation and the text vector representation by utilizing the neural network in at least one denoising iteration of a diffusion neural network to generate the digital image. Furthermore, in some implementations, the series of acts 1100 includes generating, utilizing the neural network, the digital image from the image vector representation and the text vector representation by: generating a first noise representation utilizing a first neural network of a first denoising iteration of a diffusion neural network; and generating a second noise representation utilizing a second neural network of a second denoising iteration of the diffusion neural network.

Additionally, in some implementations, the series of acts 1100 includes providing, for display via a user interface of a client device, one or more style-and-content-weight controllers; and determining, based on a user interaction with the one or more style-and-content-weight controllers, a number of low-resolution layers of the neural network for conditioning with the text vector representation without the image vector representation. Moreover, in some implementations, the series of acts 1100 includes determining, based on the user interaction with the one or more style-and-content-weight controllers, a number of high-resolution layers and a number of denoising iterations of a diffusion neural network to condition utilizing the image vector representation. Furthermore, in some implementations, the series of acts 1100 includes providing, for display via a user interface of a client device, a style-and-content-weight controller associated with the text prompt; and determining, based on a user interaction with the style-and-content-weight controller, a number of low-resolution layers of the neural network for conditioning with the text vector representation without the image vector representation.

As a further example, in some implementations, the series of acts 1100 includes generating, from a noise representation utilizing a denoising iteration of a diffusion neural network, an additional noise representation by: conditioning a first layer of a neural network of the denoising iteration with a first vector representation of a first prompt; and conditioning a second layer of the neural network of the denoising iteration with a second vector representation of a second prompt. In addition, in some implementations, the series of acts 1100 includes generating, utilizing additional denoising iterations of the diffusion neural network, a digital image from the additional noise representation, the first vector representation, and the second vector representation. Moreover, in some implementations, the series of acts 1100 includes receiving the first prompt and the second prompt for generating the digital image.

To illustrate, in some implementations, the series of acts 1100 includes conditioning the first layer of the neural network of the denoising iteration with the first vector representation by conditioning a high-resolution upsampling layer of the neural network with an image vector representation of an image prompt, wherein the high-resolution upsampling layer has a higher resolution than a low-resolution upsampling layer of the neural network. Moreover, in some implementations, the series of acts 1100 includes conditioning the second layer of the neural network of the denoising iteration with the second vector representation by conditioning the low-resolution upsampling layer of the neural network with a text vector representation of a text prompt without the image vector representation of the image prompt.

Alternatively, in some implementations, the series of acts 1100 includes conditioning the first layer of the neural network of the denoising iteration with the first vector representation by conditioning a low-resolution upsampling layer of the neural network with an image vector representation of an image prompt, wherein the low-resolution upsampling layer has a lower resolution than a high-resolution upsampling layer of the neural network. Moreover, in some implementations, the series of acts 1100 includes conditioning the second layer of the neural network of the denoising iteration with the second vector representation by conditioning the high-resolution upsampling layer of the neural network with a text vector representation of a text prompt without the image vector representation.

Furthermore, in some implementations, the series of acts 1100 includes: conditioning the first layer of the neural network by conditioning a downsampling layer of the neural network with a text vector representation of a text prompt; and conditioning the second layer of the neural network by conditioning an upsampling layer of the neural network with an image vector representation of an image prompt. In addition, in some implementations, the series of acts 1100 includes: providing, for display via a user interface of a client device, a style-and-content-weight controller; and determining, based on user interaction with the style-and-content-weight controller, a number of layers of the neural network for conditioning with the first vector representation.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 12 illustrates a block diagram of an example computing device 1200 that may be configured to perform one or more of the processes described above. One will appreciate that one or more computing devices, such as the computing device 1200 may represent the computing devices described above (e.g., the computing device(s) 1000, the server device(s) 106, or the client device 108). In one or more embodiments, the computing device 1200 may be a mobile device (e.g., a mobile telephone, a smartphone, a PDA, a tablet, a laptop, a camera, a tracker, a watch, a wearable device, etc.). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes the memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes the storage device 1206 for storing data or instructions. As an example, and not by way of limitation, the storage device 1206 can include a non-transitory storage medium described above. The storage device 1206 may include a hard disk drive (“HDD”), flash memory, a Universal Serial Bus (“USB”) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (“NIC”) or network adapter for communicating with an Ethernet or other wire-based network or a wireless NIC (“WNIC”) or wireless adapter for communicating with a wireless network, such as a WI-FI. The computing device 1200 can further include the bus 1212. The bus 1212 can include hardware, software, or both that connects components of computing device 1200 to each other.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving a text prompt and an image prompt for generating a digital image;
conditioning an upsampling layer of a neural network with an image vector representation of the image prompt;
conditioning an additional upsampling layer of the neural network with a text vector representation of the text prompt without the image vector representation of the image prompt; and
generating, utilizing the neural network, the digital image from the image vector representation and the text vector representation.

2. The method of claim 1, wherein conditioning the upsampling layer of the neural network comprises conditioning a high-resolution upsampling layer of the neural network with the image vector representation of the image prompt, wherein the high-resolution upsampling layer has a higher resolution than a low-resolution upsampling layer of the neural network.

3. The method of claim 2, wherein conditioning the additional upsampling layer of the neural network comprises conditioning the low-resolution upsampling layer with the text vector representation of the text prompt without the image vector representation of the image prompt.

4. The method of claim 2, further comprising conditioning the high-resolution upsampling layer of the neural network with the text vector representation of the text prompt.

5. The method of claim 1, wherein generating, utilizing the neural network, the digital image from the image vector representation and the text vector representation comprises utilizing the neural network in at least one denoising iteration of a diffusion neural network to generate the digital image.

6. The method of claim 1, further comprising:
providing, for display via a user interface of a client device, one or more style-and-content-weight controllers; and
determining, based on a user interaction with the one or more style-and-content-weight controllers, a number of low-resolution layers of the neural network for conditioning with the text vector representation without the image vector representation.

7. The method of claim 6, further comprising determining, based on the user interaction with the one or more style-and-content-weight controllers, a number of high-resolution layers and a number of denoising iterations of a diffusion neural network to condition utilizing the image vector representation.

8. The method of claim 1, further comprising conditioning a plurality of downsampling layers of the neural network with the text vector representation of the text prompt without the image vector representation of the image prompt.

9. A system comprising:
a memory component; and
one or more processing devices coupled to the memory component, the one or more processing devices to perform operations comprising:
receiving a first prompt and a second prompt for generating a digital image;
generating, from a noise representation utilizing a denoising iteration of a diffusion neural network, an additional noise representation by:
conditioning a first layer of a neural network of the denoising iteration with a first vector representation of the first prompt; and
conditioning a second layer of the neural network of the denoising iteration with a second vector representation of the second prompt; and
generating, utilizing additional denoising iterations of the diffusion neural network, the digital image from the additional noise representation, the first vector representation, and the second vector representation.

10. The system of claim 9, wherein conditioning the first layer of the neural network of the denoising iteration with the first vector representation comprises conditioning a high-resolution upsampling layer of the neural network with an image vector representation of an image prompt, wherein the high-resolution upsampling layer has a higher resolution than a low-resolution upsampling layer of the neural network.

11. The system of claim 10, wherein conditioning the second layer of the neural network of the denoising iteration with the second vector representation comprises conditioning the low-resolution upsampling layer of the neural network with a text vector representation of a text prompt without the image vector representation of the image prompt.

12. The system of claim 9, wherein conditioning the first layer of the neural network of the denoising iteration with the first vector representation comprises conditioning a low-resolution upsampling layer of the neural network with an image vector representation of an image prompt, wherein the low-resolution upsampling layer has a lower resolution than a high-resolution upsampling layer of the neural network.

13. The system of claim 12, wherein conditioning the second layer of the neural network of the denoising iteration with the second vector representation comprises conditioning the high-resolution upsampling layer of the neural network with a text vector representation of a text prompt without the image vector representation.

14. The system of claim 9, wherein:
conditioning the first layer of the neural network comprises conditioning a downsampling layer of the neural network with a text vector representation of a text prompt; and
conditioning the second layer of the neural network comprises conditioning an upsampling layer of the neural network with an image vector representation of an image prompt.

15. The system of claim 9, wherein the operations further comprise:
providing, for display via a user interface of a client device, a style-and-content-weight controller; and
determining, based on user interaction with the style-and-content-weight controller, a number of layers of the neural network for conditioning with the first vector representation.

16. A non-transitory computer-readable medium storing executable instructions that, when executed by a processing device, cause the processing device to perform operations comprising:
receiving a text prompt and an image prompt for generating a digital image;
conditioning an upsampling layer of a neural network with an image vector representation of the image prompt;
conditioning an additional upsampling layer of the neural network with a text vector representation of the text prompt without the image vector representation of the image prompt; and
generating, utilizing the neural network, the digital image from the image vector representation and the text vector representation.

17. The non-transitory computer-readable medium of claim 16, wherein:
conditioning the upsampling layer of the neural network comprises conditioning a high-resolution upsampling layer of the neural network with the image vector representation of the image prompt; and
conditioning the additional upsampling layer of the neural network comprises conditioning a low-resolution upsampling layer of the neural network with the text vector representation of the text prompt,
wherein the high-resolution upsampling layer has a higher resolution than the low-resolution upsampling layer.

18. The non-transitory computer-readable medium of claim 16, wherein the operations further comprise:
providing, for display via a user interface of a client device, a style-and-content-weight controller associated with the text prompt; and
determining, based on a user interaction with the style-and-content-weight controller, a number of low-resolution layers of the neural network for conditioning with the text vector representation without the image vector representation.

19. The non-transitory computer-readable medium of claim 16, wherein generating, utilizing the neural network, the digital image from the image vector representation and the text vector representation comprises:
generating a first noise representation utilizing a first neural network of a first denoising iteration of a diffusion neural network; and
generating a second noise representation utilizing a second neural network of a second denoising iteration of the diffusion neural network.

20. The non-transitory computer-readable medium of claim 16, wherein the operations further comprise conditioning a plurality of downsampling layers of the neural network with the text vector representation of the text prompt.
